(19) United States
(12) Patent Application Publication
(10) Pub. No.: US 2023/0314323 A1
(43) Pub. Date: Oct. 5, 2023

(54) METHOD AND APPARATUS FOR DETECTING SUNSCREEN ON SKIN HAVING VARIOUS COSMETIC PRODUCT LAYERS

(71) Applicant: L'OREAL, Paris (FR)

(72) Inventors: Chin Kai Lee, Kawasaki-shi (JP); Charlotte Pellet, Kawasaki-shi (JP); Woo Ram Park, Kawasaki-shi (JP)

(73) Assignee: L'OREAL, Paris (FR)

(21) Appl. No.: 18/042,977

(22) PCT Filed: Sep. 21, 2021
(86) PCT No.: PCT/JP2021/035475

§ 371 Date: Feb. 24, 2023

(30) Foreign Application Priority Data
Sep. 29, 2020 (JP) 2020-163485
Oct. 22, 2020 (FR) 2010837

(51) Int. Cl. G01N 21/64

(52) U.S. Cl. CPC G01N 21/645; G01N 21/6445; G01N 2021/6471; G01N 2021/8433

(57) ABSTRACT

The present invention provides a method and an apparatus for easily and precisely detecting an effect of sunscreen (12) based on results of clinical examinations even if various cosmetic layers (14) are provided on the skin (10). The present invention provides an apparatus (1) for detecting a sunscreen (12), comprising: a light source (2); an ultraviolet light pass filter (4) provided between the light source (2) and an irradiation target (10); a visible light sensor (6); and a polarizer (8) provided between the visible light sensor (6) and the irradiation target (10), wherein the ultraviolet light pass filter (4) is configured to pass light (16) having a wavelength in an ultraviolet light range among light emitted from the light source (2), wherein the irradiation target (10) includes at least one substance emitting fluorescent light (20) in response to the light irradiation (16), wherein the polarizer (8) is configured to block at least a part of light (18) emitted from the light source (2) and reflected by the irradiation target (10), and wherein the visible light sensor (6) is configured to determine an intensity of the fluorescent light (20) passing through the polarizer (8).

### TECHNICAL FIELD

The present invention relates to a method and an apparatus for detecting sunscreen on a skin having various cosmetic product layers.

### Background

Protection of skin from ultraviolet light (UV production) is important for skin health and beauty. However, since ultraviolet light is invisible for human eye, the UV protection is also invisible. In other words, even if a product having a UV protection effect, i.e., a sunscreen is applied on a skin of a consumer, the consumer cannot visually check whether or not the product has been applied enough to provide sufficient protection and to cover the entire skin.

From various studies, dynamics of UV protection on a skin have been reported. However, since a consumer does not have ways for evaluating an effect of sunscreen in real time, the consumer cannot recognize the effect of sunscreen. The most popular evaluation method of sunscreen is SPF or PA. However, all the methods for determining these indicators require clinical evaluations taking longer than 24 hours for analyzing the effect.

Furthermore, sunscreen is, in general, included in, or used in combination with other cosmetic products such as foundation rather than being used alone. Therefore, it is necessary to evaluate the sunscreen effect even if other cosmetic products are applied with sunscreen.

The present invention provides a method and an apparatus for easily and precisely detecting an effect of sunscreen based on results of clinical examinations even if various cosmetic layers are provided on a skin.

### SUMMARY OF INVENTION

### Solution to Problem

The first embodiment of the present invention provides an apparatus for detecting a sunscreen, comprising:
a light source;
an ultraviolet light pass filter provided between the light source and an irradiation target;
a visible light sensor; and
a polarizer provided between the visible light sensor and the irradiation target,
wherein the ultraviolet light pass filter is configured to pass light having a wavelength in an ultraviolet light range among light emitted from the light source,
wherein the irradiation target includes at least one substance emitting fluorescent light in response to the light irradiation,
wherein the polarizer is configured to block at least a part of light emitted from the light source and reflected by the irradiation target, and
wherein the visible light sensor is configured to determine an intensity of the fluorescent light passing through the polarizer.

In the first embodiment of the present invention, the ultraviolet light pass filter may be configured to pass ultraviolet light having a wavelength in a range between 320 and 400 nm.

In the first embodiment of the present invention, the ultraviolet light pass filter may be configured to pass ultraviolet light having a wavelength in a range between 280 and 320 nm.

In the first embodiment of the present invention, the apparatus may be further configured to detect ultraviolet light protection effect of the applied sunscreen by comparing an intensity of the fluorescent light detected by the visible light sensor when the sunscreen has been applied to the irradiation target, with an intensity of the fluorescent light preliminarily detected by the visible light sensor and stored when the sunscreen has not been applied to the irradiation target.

In the first embodiment of the present invention, the substance emitting fluorescent light included in the irradiation target may be a substance emitting fluorescent light in response to irradiation of ultraviolet light.

In the first embodiment of the present invention, the irradiation target may be a dummy sample including a substance emitting fluorescent light in response to ultraviolet light, the substance being included in human skin.

In the first embodiment of the present invention, the irradiation target may be human skin.

The second embodiment of the present invention provides a method for detecting sunscreen, comprising steps of;
emitting light from a light source;
passing the light emitted from the light source through an ultraviolet light pass filter to allow light having a wavelength in an ultraviolet light range to transmit the ultraviolet light pass filter;
irradiating an irradiation target including at least one substance emitting fluorescent light in response to light irradiation with light passing through the ultraviolet light pass filter;
emitting fluorescent light in response to the irradiation from the irradiation target;
passing the fluorescent light through a polarizer; and
detecting an intensity of the fluorescent light passing through the polarizer by a visible light sensor.

In the second embodiment of the present invention, the ultraviolet light pass filter may pass ultraviolet light having a wavelength in a range between 320 and 400 nm.

In the second embodiment of the present invention, the ultraviolet light pass filter may pass ultraviolet light having a wavelength in a range between 280 and 320 nm.

In the second embodiment of the present invention, the method may further comprise determining an ultraviolet light protection effect of applied sunscreen by comparing an intensity of the fluorescent light detected by the visible light sensor when the sunscreen has been applied to the irradiation target, with an intensity of the fluorescent light preliminarily detected by the visible light sensor and stored when the sunscreen has not been applied to the irradiation target.

In the second embodiment of the present invention, the substance emitting the fluorescent light included in the irradiation target may be a substance emitting the fluorescent light in response to the irradiation of ultraviolet light.

In the second embodiment of the present invention, the irradiation target may be a dummy sample including a substance emitting the fluorescent light in response to ultraviolet light included in human skin.

In the second embodiment of the present invention, the irradiation target may be human skin.

### BRIEF DESCRIPTIONS OF DRAWINGS

FIG. 1 shows a schematic diagram of an apparatus for detecting sunscreen according to the embodiment of the present invention.

FIG. 2 shows a flow chart of a method for detecting sunscreen according to the embodiment of the present invention.

### DESCRIPTION OF EMBODIMENTS

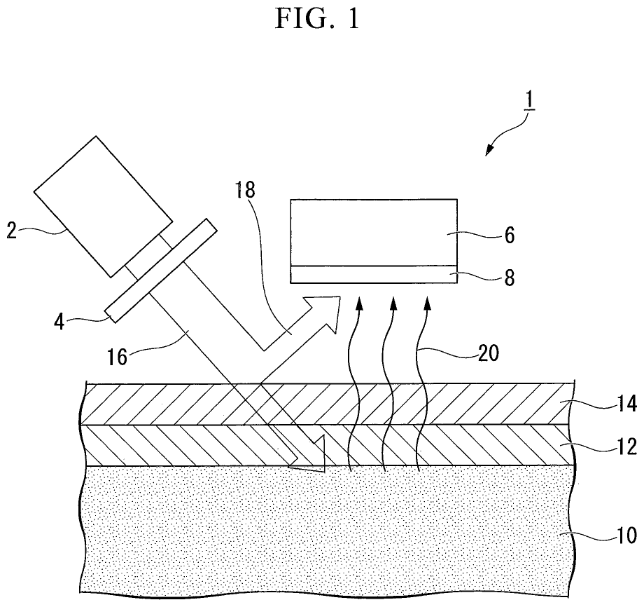

An apparatus 1 for detecting sunscreen according to some embodiments of the present invention may comprise: a light source 2; an ultraviolet light pass filter 4 provided between the light source 2 and an irradiation target 10; a visible light sensor 6; and a polarizer 8 provided between the visible light sensor 6 and the irradiation target 10 as shown in FIG. 1. The light source 2 may emit light 16 including ultraviolet light. The ultraviolet light pass filter 4 may be configured to transmit light 16 having a wavelength within an ultraviolet light range among the light 16 emitted from the light source 2. The irradiation target 10 may include at least one substance emitting fluorescent light 20 in response to irradiation of the light, in particular, ultraviolet light. A part 18 of the light emitted from the light source may be reflected by the irradiation target 10 toward the visible light sensor 6. However, the reflected light 18 may be blocked by the polarizer 8 provided between the visible light sensor 6 and the irradiation target 10. Therefore, most of the reflected light 18 does not impinge the visible light sensor 6. On the other hand, the fluorescent light 20 emitted from the irradiation target 10 may impinge the visible light sensor 6 after passing through the polarizer 8, and the visible light sensor 6 may detect an intensity of the fluorescent light 20.

The light source 2 may emit light 16 including ultraviolet light. For example, the light source 2 may emit light having a wide range wavelength including ultraviolet light, visible light, and infrared light. Alternatively, the light source 2 may emit only ultraviolet light. For example, the light source 2 may be an ultraviolet LED emitting a monochromatic ultraviolet light, for example, having a wavelength of 365 nm. An ultraviolet LED is advantageous for its small size, low power consumption, and low cost.

The ultraviolet light pass filter 4 may be, for example, configured to pass ultraviolet light having a wavelength within a range between 320 and 400 nm (UV-A) and/or ultraviolet light having a wavelength within a range between 280 and 320 nm (UV-B). The ultraviolet light pass filter 4 may be configured to not pass light having a wavelength other than ultraviolet light. The ultraviolet light pass filter 4 may be, for example, directly attached in front of the light source 2. Alternatively, the ultraviolet light pass filter 4 may be disposed separately from the light source 2 at a predetermined distance. Optics such as lenses, collimators, and polarizers for focusing and guiding light may be disposed between the light source 2 and the ultraviolet light pass filter 4, or between the ultraviolet light pass filter 4 and the irradiation target 10.

The irradiation target 10 may be, for example, human skin. The human skin includes at least one fluorescent substance emitting fluorescent light 20, for example, within a range of visible light in response to the irradiation of light, in particular, ultraviolet light. Such a fluorescent substance may be, for example, collagen, NADPH, or amino acids. Alternatively, the irradiation target 10 may be a dummy sample including at least one fluorescent substance similar to that included in the human skin, for example, a pigskin, a cultured human skin, or a gel modeling human skin.

A sunscreen 12 may be applied on the irradiation target 10. Optionally, a cosmetic product layer 14 may be applied on the sunscreen 12. Alternatively, the sunscreen 12 may be included in the cosmetic product layer 14.

The polarizer 8 provided between the visible light sensor 6 and the irradiation target 10 may be, for example, a linear polarizer or a circular polarizer. The polarizer 8 may be directly attached in front of the visible light sensor 6. Alternatively, the polarizer 8 may be disposed separately from the visible light sensor 6 at a predetermined distance. Optics such as lenses, collimators, and polarizers for focusing and guiding light may be disposed between the visible light sensor 6 and the polarizer 8, or between the polarizer 8 and the irradiation target 10.

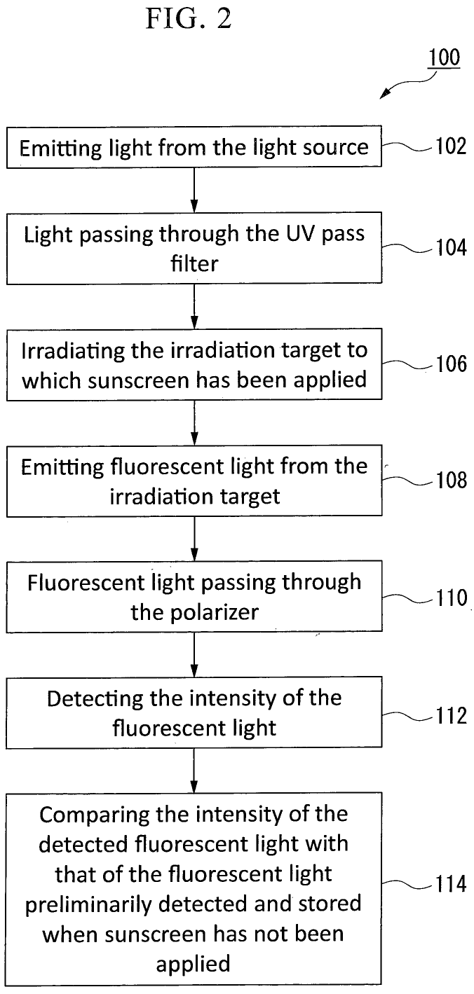

A method 100 for detecting sunscreen using such an apparatus 1 for detecting sunscreen will be discussed with reference to FIG. 2.

In the step 102, light 16 is emitted from the light source 2. The emitted light 16 may include ultraviolet light. For example, the emitted light 16 may have a wide range wavelength including ultraviolet light, visible light, and infrared light. Alternatively, the emitted light 16 may be only ultraviolet light. For example, the light 16 may be a monochromatic ultraviolet light, for example, having a wavelength of 365 nm.

In the step 104, the light 16 emitted from the light source passes through the ultraviolet light pass filter 4 which allows light having a wavelength within an ultraviolet light range to transmit. The ultraviolet light pass filter 4 may pass ultraviolet light within a range between 320 and 400 nm (UV-A) and/or ultraviolet light within a range between 280 and 320 nm (UV-B).

In the step 106, the irradiation target 10 including at least one substance emitting fluorescent light in response to the irradiation of light, in particular, the irradiation of ultraviolet light is irradiated with the light 16 passing through the ultraviolet light pass filter 4. Such a substance emitting fluorescent light in response to the irradiation of light may be, for example, collagen, NADPH, or amino acids. Such an irradiation target 10 may be, for example, human skin. Alternatively, such an irradiation target 10 may be a pigskin, a cultured human skin, or a gel modeling human skin, which include the fluorescent substances.

In the step 108, the irradiation target 10 emits fluorescent light 20 in response to the irradiation of light, in particular, the irradiation of ultraviolet light. The fluorescent light 20 may have a wavelength, for example, within a range of visible light.

In the step 110, the fluorescent light 20 emitted from the irradiation target 10 passes through the polarizer 8. The polarizer 8 may be, for example, a linear polarizer or a circular polarizer. A part 18 of the light emitted from the light source 2 may be reflected by the irradiation target 10 toward the visible light sensor 6. However, the reflected light 18 may be blocked by the polarizer 8 disposed between the visible light sensor 6 and the irradiation target 10. Therefore, most of the reflected light 18 does not impinge the visible light sensor 6.

In the step 112, an intensity of the fluorescent light 20 passing through the polarizer 8 may be detected by the visible light sensor 6.

In the step 114, the intensity of the fluorescent light 20 detected by the visible light sensor 6 is compared with an intensity of fluorescent light preliminarily detected and stored when the sunscreen has not been applied to the irradiation target. If the sunscreen 12 has been applied to the irradiation target 10, the amount of the ultraviolet light achieving the irradiation target 10 is reduced compared to the case in which the sunscreen 12 is not applied. The intensity of the fluorescent light 20 emitted from the irradiation target 10 by the irradiation of the ultraviolet light is also reduced. Therefore, the ultraviolet light blocking effect of the sunscreen 12 can be determined by comparing the detected intensity of the fluorescent light 20 with the intensity of the fluorescent light 20 when the sunscreen 12 has not been applied.

Such an apparatus 1 and a method 100 for detecting sunscreen may be, in particular, significantly advantageous when other cosmetic products 14 such as a foundation are applied in addition to the sunscreen 12, and when a cosmetic product 14 incorporating a sunscreen effect is applied. Some cosmetic products may also have a function adding a glittering effect on an appearance. Such a cosmetic product having a glittering effect may include non-absorbing filters, scattering substances, or reflecting substances that significantly scatter and/or reflect environment light. If such a reflective cosmetic product has been applied on the layer of the sunscreen, conventional detecting apparatuses, for example, not comprising a polarizer between a visible light sensor and an irradiation target, may not be able to precisely detect the amount of fluorescent light due to noise caused by irradiation light reflected on the irradiation target and impinging the visible light sensor. On the other hand, if a polarizer 8 is provided between the visible light sensor 6 and the irradiation target 10 as the present invention, the irradiation light reflected on the irradiation target 10 may be blocked by the polarizer 8. Therefore, the irradiation light reflected on the irradiation target 10 and impinging the visible light sensor 6 and therefore the noise can be significantly reduced. This results in an accurate measurement of the intensity of the fluorescent light 20 emitted from the irradiation target 10.

Since the apparatus 1 implementing such a method for detecting the sunscreen 12 can precisely detect the amount of the sunscreen 12 with a simple configuration, for example, the apparatus 1 can be incorporated into a portable miniaturized device to detect the amount of the sunscreen within a short time. Therefore, it is also possible to easily determine whether or not the sunscreen has been evenly applied to the entire skin by carrying out the measurements, for example, at a plurality of portions of the skin.

Table 1 shows reductions of intensities of light from skin, to which sunscreen and/or cosmetic products have been applied, compared with bare skin, to which no sunscreen or cosmetic products have been applied, the light being detected by visible light sensors of the detecting apparatus comprising the ultraviolet light pass filter and the polarizer according to the embodiment of the present invention, and a detecting device comprising either one of the ultraviolet light pass filter and the polarizer, and a detecting device comprising neither the ultraviolet light pass filter nor the polarizer. The sample 1 is human skin to which 1 mg/cm² of an SPF 50 sunscreen has been applied. The sample 2 is human skin to which 2 mg/cm² of an SPF 50 sunscreen has been applied. The sample 3 is human skin to which 2mg/cm² of an SPF 50 sunscreen and a foundation have been applied. The sample 4 is human skin to which a cosmetic product having a function of adding a glittering effect to a skin has been applied.

TABLE 1
Reductions of intensities of light from skin, to which sunscreen and/or
cosmetic products have been applied, compared with bare skin, to which no sunscreen
or cosmetic products have been applied, the light being detected by visible light
sensors.

| | Apparatuses for detecting light | | | |
|---|---|---|---|---|
| | Comprising | | | |
| | the ultraviolet | | | |
| | light pass filter | | | Comprising |
| | and the polarizer | Comprising | | neither the |
| | according to the | only the | | ultraviolet |
| | embodiment of | ultraviolet | Comprising | light pass |
| | the present | light pass | only the | filter nor the |
| | invention | filter | polarizer | polarizer |
| Sample 1 | 62.54% | 49.44% | 26.51% | 37.56% |
| (SPF 50 | | | | |
| 1 mg/cm²) | | | | |
| Sample 2 | 63.75% | 57.94% | 33.75% | 37.56% |
| (SPF 50 | | | | |
| 2mg/cm²) | | | | |
| Sample 3 | 62.33% | 24.45% | 19.62% | 12.04% |
| (SPF 50 | | | | |
| 2 mg/cm² and | | | | |
| foundation) | | | | |
| Sample 4 | 30.29% | 1.64% | 7.43% | 4.88% |
| (Glittering | | | | |
| cosmetic | | | | |
| product) | | | | |

Regarding the samples 1 and 2, the applications of 1 mg/cm² and 2 mg/cm² of the SPF 50 sunscreen reduced the intensity of light detected by the visible light sensor of the detecting apparatus comprising the ultraviolet light pass filter and the polarizer according to the embodiment of the present invention by 62.54% and 63.75%, respectively. On the other hand, the reductions of the intensities of light detected by the apparatuses comprising only the ultraviolet light pass filter, comprising only the polarizer, and comprising neither the ultraviolet light pass filter nor the polarizer were small. Therefore, it can be found that noise caused by light reflected by the irradiation target was reduced and the reduction of the fluorescent light emitted from the irradiation target was accurately measured.

Although a foundation was applied over the sunscreen layer in the sample 3, the reduction of the fluorescent light similar to the sample 2 was measured by the apparatus for detecting sunscreen according to the embodiment of the present invention. However, the reductions of the intensities of light detected by the detecting apparatuses comprising only one of the ultraviolet light pass filter and the polarizer, and comprising neither the ultraviolet light pass filter nor the polarizer were small. Therefore, it can be found that the apparatus for detecting sunscreen according to the embodiment of the present invention effectively blocked the reflection of the irradiation light by the foundation and that the reduction of the fluorescent light emitted from the irradiation target was accurately measured.

Furthermore, in a case that the cosmetic product of the sample 4 having a function reflecting environment light and adding a glittering effect to a skin, the detecting apparatus according to the embodiment of the present invention measured the reduction of the intensity of the detected light, while the intensities of light detected by the apparatuses comprising only one of the ultraviolet light pass filter and the polarizer and the apparatus comprising neither the ultraviolet light pass filter nor the polarizer was reduced very little. Therefore, it can be found that the apparatus for detecting sunscreen according to the embodiment of the present invention accurately measured the reduction of the fluorescent light emitted from the irradiation target even in a case that the cosmetic product having a function reflecting environmental light and adding a glittering effect to a skin was applied.

Although the embodiments of the present invention were described, those skilled in the art would easily understand that various changes, modifications and improvements are possible without departing from the technical spirit and scope of the present invention.

### REFERENCE SIGNS LIST

1: Apparatus for detecting sunscreen
2: Light source;
4: Ultraviolet light pass filter
6: Visible light sensor
8: Polarizer
10: Irradiation target
12: Sunscreen
14: Cosmetic product layer
16: Light
18: Reflected light
20: Fluorescent light

1. An apparatus for detecting a sunscreen, comprising:
a light source;
an ultraviolet light pass filter provided between the light source and an irradiation target;
a visible light sensor; and
a polarizer provided between the visible light sensor and the irradiation target,
wherein the ultraviolet light pass filter is configured to pass light having a wavelength in an ultraviolet light range among light emitted from the light source,
wherein the irradiation target includes at least one substance emitting fluorescent light in response to the light irradiation,
wherein the polarizer is configured to block at least a part of light emitted from the light source and reflected by the irradiation target, and
wherein the visible light sensor is configured to detect an intensity of the fluorescent light passing through the polarizer.

2. The apparatus according to claim 1, wherein the ultraviolet light pass filter is configured to pass ultraviolet light having a wavelength in a range between 320 and 400 nm.

3. The apparatus according to claim 1, wherein the ultraviolet light pass filter is configured to pass ultraviolet light having a wavelength in a range between 280 and 320 nm.

4. The apparatus according to claim 1, configured to determine ultraviolet light protection effect of the applied sunscreen by comparing an intensity of the fluorescent light detected by the visible light sensor when the sunscreen has been applied to the irradiation target, with an intensity of the fluorescent light preliminarily detected by the visible light sensor and stored when the sunscreen has not been applied to the irradiation target.

5. The apparatus according to claim 1, wherein the at least one substance emitting fluorescent light included in the irradiation target is a substance emitting fluorescent light in response to irradiation of ultraviolet light.

6. The apparatus according to claim 1, wherein the irradiation target is a dummy sample including a substance emitting fluorescent light in response to ultraviolet light, the substance being included in human skin.

7. The apparatus according to claim 1, wherein the irradiation target is human skin.

8. A method for detecting sunscreen, comprising steps of:
emitting light from a light source;
passing the light emitted from the light source through an ultraviolet light pass filter to allow light having a wavelength in an ultraviolet light range to transmit the ultraviolet light pass filter;
irradiating an irradiation target including at least one substance emitting fluorescent light in response to light irradiation with light passing through the ultraviolet light pass filter;
emitting fluorescent light in response to the irradiation from the irradiation target;
passing the fluorescent light through a polarizer; and
detecting an intensity of the fluorescent light passing through the polarizer by a visible light sensor.

9. The method according to claim 8, wherein the ultraviolet light pass filter passes ultraviolet light having a wavelength in a range between 320 and 400 nm.

10. The method according to claim 8, wherein the ultraviolet light pass filter passes ultraviolet light having a wavelength in a range between 280 and 320 nm.

11. The method according to claim 8, further comprising determining an ultraviolet light protection effect of applied sunscreen by comparing an intensity of the fluorescent light detected by the visible light sensor when the sunscreen has been applied to the irradiation target, with an intensity of the fluorescent light preliminarily detected by the visible light sensor and stored when the sunscreen has not been applied to the irradiation target.

12. The method according to claim 8, wherein the at least one substance emitting the fluorescent light included in the irradiation target is a substance emitting the fluorescent light in response to the irradiation of ultraviolet light.

13. The method according to claim 8, wherein the irradiation target is a dummy sample including a substance emitting the fluorescent light in response to ultraviolet light included in human skin.

14. The method according to claim 8, wherein the irradiation target is human skin.
